(19) United States
(12) Patent Application Publication
(10) Pub. No.: US 2016/0263540 A1
(43) Pub. Date: Sep. 15, 2016

(54) SILANIZED HIGHLY HYDROPHOBIC SILICIC ACIDS

(71) Applicant: WACKER CHEMIE AG, München (DE)

(72) Inventor: Achim SCHNEIDER, Burghausen (DE)

(21) Appl. No.: 15/035,938

(22) PCT Filed: Nov. 19, 2014
(86) PCT No.: PCT/EP2014/075011

§ 371 Date: May 11, 2016

(30) Foreign Application Priority Data
Nov. 27, 2013 (DE) 102013224210.7

(51) Int. Cl. B01F 17/54; C09J 11/06; C09D 7/12; C01B 33/12; C07F 7/18

(52) U.S. Cl. CPC B01F 17/0071; C01B 33/12; C07F 7/1836; C09D 7/1233; C09J 11/06; C08K 9/06

(57) ABSTRACT

Hydrophilic silicas, especially pyrogenic hydrophilic silicas, when hydrophobicized with alkoxysilanes bearing lower alkoxy groups and C₁₂ and C₁₄ hydrocarbon groups, exhibit higher hydrophobicity and uniformity of hydrophobicization as compared to silicas hydrophobicized with alkoxy silanes bearing hydrocarbon groups with greater carbon content.

### CROSS REFERENCE TO RELATED APPLICATIONS

This application is the U.S. National Phase of PCT Appln. No. PCT/EP2014/075011 filed Nov. 19, 2014, which claims priority to German Application No. 10 2013 224 210.7 filed Nov. 27, 2013, the disclosures of which are incorporated in their entirety by reference herein.

### BACKGROUND OF THE INVENTION

1. Field of the Invention

The invention relates to silicic acids which are surface-modified with a compound from the group (RO)₃SiR′, where R′═CₙH₂₍ₙ₋ₘ₎₊₁, n=9 to 14, m=0 to n and R=C_{q}H_{2q+1} where q=1 to 4, and to a method of producing the silicic acids and their use as thickeners, antiblocking agents, flow enhancers, and for controlling charging properties.

2. Description of the Related Art

The surface of unmodified silicic acid which is produced, e.g. by the route of a wet-chemical precipitation process or by hydrolysis of tetrachlorosilane in a hydrogen flame, is covered with silanol groups, as a result of which the materials possess a hydrophilic character. By means of silylation for example with hexamethyldisilazane (DE 2043 629), dichlorosilane (DE 1 163 784 B) or polydimethylsiloxane (EP 0 686 676 A1), it is possible to significantly reduce the number of silanol groups located on the surface. On account of the organosilicon surface modification, the silicic acid is given a hydrophobic character to a greater or lesser extent.

On account of the changed surface nature associated with the modification, surface-modified silicic acids often behave considerably differently from the nonmodified representatives in many applications. Thus, for example, surface-modified, hydrophobic silicic acids are often characterized, compared to the nonmodified starting silicic acid, by significantly higher thickening effect, particularly in systems such as solvents, polymers or resins which have polar groups, such as, for example, hydroxy-, keto-, epoxy-, ether-, ester-, or carboxyl-groups, or nitrogen-containing groups such as primary, secondary, or tertiary amino, amido or ammonium groups. Of particular industrial relevance in this connection are, for example, epoxy resins, polyurethanes, unsaturated polyester resins and aqueous dispersions and emulsions, which are used for example as paints, coatings or adhesives.

For example, DE 44 19 234 A1 describes a method for the silylation of inorganic oxides, wherein the very finely divided inorganic oxides are treated with at least one silylating agent that is semi-volatile in the temperature range of the method. Inter alia, DE 44 19 234 A1 relates to a highly nonpolar silicic acid produced by this method. The examples listed in the specification reveal that the thickening effect, for example in a 25% strength aqueous ethanol solution, increases with increasing hydrophobic character of the silicic acid. The hydrophobic character of the silicic acid was ascertained then by visual assessment of the wetting behavior of the samples compared to methanol/water mixtures of different compositions and given as a “methanol” number (defined as the percent by weight of methanol in the water/methanol mixture, at which half of the silicic acid is wetted and has sunk into the liquid).

EP 0 672 731 B1 describes the production of pyrogenic silicas by treatment with compounds of the formula (RO)₃SiCₙH₂ₙ₊₁, where n=10 to 18 and R=short-chain alkyl radicals, such as e.g. methyl radicals, ethyl radicals or the like. These are suitable particularly for the thickening of liquids. In the examples, the compounds used for treating the silicic acids were hexadecyltrimethoxysilane (H₃CO)₃SiC₁₆H₃₃ and octadecyltrimethoxysilane (H₃CO)₃SiC₁₈H₃₇.

The investigated samples of increasing degree of coating (i.e. increasing amount of silane used for the modification, based on the specific surface area corresponding to the data in table 3) are characterized, compared to the non-surface-modified starting silicic acid Aerosil® 200 (example 9), by a significantly higher thickening of a liquid 1:1 mixture of propanol/water (see table p. 9). If one considers the modification with (H₃CO)₃SiC₁₆H₃₃ (silane I), the increasing degree of coating is evident from an increasing C content (cf. table 4). Although the cited specification does not explicitly discuss the hydrophobicity of the samples, examples 11 to 14 nevertheless clearly show that a decreasing percentage C content of the silicic acids from example 4 via example 5 and 6 to example 7 is associated with a significant decrease in thickening effect. The C content gives direct information about the fraction of nonpolar hydrocarbons present on the silicic acid that are responsible for the hydrophobic character. Accordingly, an increasing C content is usually linked to a stronger hydrophobic character of the silicic acid.

The feed materials used, however, hexadecyltrimethoxysilane (H₃CO)₃SiC₁₆H₃₃ and octadecyltrimethoxysilane (H₃CO)₃SiC₁₈H₃₇, have significant disadvantages from the point of view of processing considerations. For example, the production of octadecyltrimethoxysilane has proven to be very complex and cost-intensive, for example on account of comparatively high melting and boiling points. Moreover, the comparatively high viscosities of the specified compounds also become noticeable in a negative context in the production processes usually used and/or product quality (the kinematic viscosity according to DIN 51562-1 of hexadecyltrimethoxysilane (H₃CO)₃SiC₁₆H₃₃ is 7.2 mm²/s at 25° C.)

As explained in EP 1 302 444 A1, silylating agents are often preferably added to the pulverulent silicic acid in liquid form as a finely divided aerosol, e.g. achieved by nozzle techniques. To achieve the finest possible aerosol droplets and the best possible jet quality, i.e. the most uniform possible droplet size distribution and their distribution in the entire range of the spray cone, a low viscosity is advantageous during spraying. Thus, through uniform distribution of the silylating agent into fine aerosol droplets, it is possible to attain a uniform distribution of the coating agent and thus homogeneous modification of the surface of the silicic acid even within relatively short residence times.

Besides being used as agents for controlling rheology, surface-modified silicic acids are also used inter alia, as flow enhancers, antiblocking agents or for controlling triboelectric charging. Of particular relevance industrially in this connection is the use as an additive in toner formulations.

Thus, for example, EP 1 502 933 A2 and EP 0 713 153 A2 describe toner formulations of this kind which, besides the toner particles, which are composed essentially of a binder resin and the corresponding pigments, also comprise hydrophobic inorganic particles such as e.g. hydrophobic pyrogenic silicic acid, to which is attributed decisive importance during control of flow behavior and charging behavior.

EP 1 502 933 A2 discloses that in order to achieve a superior flow behavior, a uniform chargeability and a good stability, even under wet conditions, a greatly pronounced and uniform as possible hydrophobic character of the inorganic particles is desired (see e.g. paragraph [0048] and [0049]).

EP 1 302 444 A1 also describes, inter alia in paragraphs [0010] and [0011], problems which can arise when using less well hydrophobicized silicic acid as antiblocking agents, flow enhancers and/or charge regulators. Moreover, the specification discusses that less well hydrophobicized silicic acids can be technically inferior on account of problems connected with miscibility and compatibility when used as active fillers in liquid systems, and, polymer or resin systems of moderate and high polarity.

From an applications point of view, as greatly a hydrophobic character which as pronounced as possible of the silicic acids and a uniform distribution of the coating agents over the surface of the silicic acids during the modification reaction are required.

The hydrophobic character of silicic acids is often controlled by varying their degree of coating. In many cases, this can be effected comparatively easily through varying the amounts of the coating agent and optionally adapting processing conditions. Thus, the use of larger amounts of the coating agent used for the surface modification, as described for example in EP 0 686 676 A1, leads to a non-water-wettable product with very small residual silanol contents (determined according to G.W. Sears et al. Analytical Chemistry 1956, 28, 1981ff), whereas the products described in EP 1 433 749 A1 are wetted by water on account of the lower degree of coating and high residual silanol contents.

At very high degrees of coating, however, a further increase in coating agent does not lead to a further reduction in residual silanol content. On account of steric considerations, it is not possible to silylate all silanol groups on the surface of the silicic acid. If the entire surface of the silicic acid is already uniformly covered, a further increase in coating agent accordingly does not lead to a decrease in residual silanol content.

Moreover, a significant increase in coating agent is often associated with technical disadvantages. Thus, for example, the fraction of organosilicon constituents which are not chemically bonded to the surface of the silicic acid increases, which, in a large number of applications, can lead to serious problems, since organosilicon compounds are known to have a tendency towards phase separation on account of their incompatibility with many other chemical compounds. As a result of this, silicone oil or silicone resin droplets can form, which become evident for example in the case of paints in the form of defects, so-called “silicone craters”. Similarly, the formation of a silicone film can have adverse effects on the desired application, e.g. the adhesion of an epoxide adhesive. For this reason, it is often desirable to use the smallest amounts possible of an organosilicon coating agent for surface modification in order to prevent such problems.

A further increase in the degree of coating is often also undesired from safety considerations. Thus, for a silicic acid sample which has a higher degree of coating for an identical chemical nature of the surface modification, during the determination of the explosion parameters of a dust/air mixture in accordance with EN14034, more critical values are ascertained, which suggests an increased hazard potential, which in turn necessitates greater safety measures. In many cases, the dust explosivity is directly connected to the carbon content of the silicic acid samples since often only the hydrocarbon radicals are available for the oxidative decomposition processes underlying an explosion.

### SUMMARY OF THE INVENTION

It is an object of the present invention to overcome the disadvantages of the current prior art and to provide silicic acids which are highly hydrophobic and can therefore be used particularly well for controlling the rheological or triboelectric properties of liquid media or as flow enhancers. These and other objects are achieved by the provision of silicic acids which are surface-modified with a compound of the formula (RO)₃SiR′, where R′═CₙH₂₍ₙ₋ₘ₎₊₁, n=9 to 14, m=0 to n and R=C_{q}H_{2q+1} where q=1 to 4. Accordingly, the silicic acids according to the invention have, on the surface, groups of the general formula R′SiO_{3/2}, where R′═CₙH₂₍ₙ₋ₘ₎₊₁ where n=9 to 14, and m=0 to n.

### DETAILED DESCRIPTION OF THE PREFERRED EMBODIMENTS

According to the invention, the value m is between 0 and n, where, as stated above, n=9 to 14. Preferably, the value for m is between 0 and 7 and particularly preferably between 0 and 1.

The radicals R are preferably short-chain alkyl groups such as e.g. methyl, ethyl, propyl or butyl groups, more preferably methyl or ethyl groups. In a particularly preferred embodiment, R are methyl groups.

The general formula (RO)₃SiR′ includes the formulae (R¹O)₃SiR′, (R²O)₂(R³O)SiR′), (R²O) (R³O)₂SiR′ and/or (R⁴O) (R⁵O) (R⁶O)SiR′ and when R describes the individual radicals R¹ to R⁶, these are as defined at the start for R and can be different or identical. Preferably, the groups selected for R are identical.

R′ is a monovalent, optionally mono- or polyunsaturated, optionally branched aliphatic or aromatic hydrocarbon radical having 9 to 14 carbon atoms. The radicals R′ are, for example, alkyl groups such as nonyl, decyl, undecyl, dodecyl, tridecyl and tetradecyl groups. The radicals R′ may be unsaturated hydrocarbon radicals, and these preferably have the unsaturated unit at the end of the hydrocarbon radical. The preferred unsaturated radicals R′ are thus non-8-enyl, dec-9-enyl, undec-10-enyl, dodec-11-enyl, tridec-12-enyl and tetradec-13-enyl, non-8-ynyl, dec-9-ynyl, undec-10-ynyl, dodec-11-ynyl, tridec-12-ynyl and tetradec-13-ynyl groups. The unsaturated units can, however, also be present at other points on the hydrocarbon chain, such as e.g. in the dodec-9-enyl, dodec-7-enyl, dodec-5-enyl or dodec-3-enyl groups. The radicals R′ can moreover optionally be polyunsaturated, such as e.g. dodeca-7,9,11-triene groups.

The radicals R′ as in aforementioned examples are preferably unbranched radicals. However, it is also possible to use mono- or polybranched groups such as e.g. 1-methyl-nonyl or 1,1-dimethyl-decyl radicals. Moreover, the unsaturated radicals R′ may be aromatic groups such as e.g. mesityl, naphthyl, biphenyl, phenanthrenyl or anthracenyl groups.

Moreover, the radicals R′ can contain heteroatoms and these may be e.g. cholinyl, isocholinyl or acridinyl groups or else aryl, alkyl, alkenyl or alkynyl groups substituted with primary, secondary or tertiary amino groups.

The radicals R′ are preferably linear unbranched alkyl, alkenyl or alkynyl groups. Most preferably, the radicals R′ are decyl, dodecyl and tetradecyl groups.

The silicic acids can be modified on the surface with exclusively one type of the groups R′SiO_{3/2}. However, it is also possible for two or more different groups to be present on the surface of the modified silicic acids which differ in the radical R′, i.e. the group R′SiO_{3/2} can include the groups R^{1-t}SiO_{3/2}, where the individual radicals R¹, R², R³ etc. to R^{t} are selected from the groups defined above for R′. Thus, for example, two R′SiO_{3/2} groups bonded to the surface could differ in the length of their carbon chains. Preferably, the surface of the metal oxide is modified exclusively with one type of the aforementioned groups R′.

The surface of the silicic acids can have further groups as well as the aforementioned groups. In this connection, preference is given to trimethylsiloxy (Me₃SiO_{1/2}), dimethylsiloxy (Me₂SiO_{2/2}) or monomethylsiloxy groups (MeSiO_{3/2}) where Me is a methyl group. The other groups present on the surface, however, are not limited to those specified. Rather, all of the surface groups known in the prior art may be present on the silicic acids.

As is known to one skilled in the art, the increase in the chain length of a homologous series of chemical compounds with a polar end group is associated with a decrease in hydrophilicity, that is to say an increase in hydrophobicity, since the hydrophobic properties of the organic group are increasingly predominant.

Thus, for example, the short-chain representatives of the monohydric primary, linear, unbranched alcohols H₂ₙ₊₁CₙOH up to propan-1-ol (n=1-3) are infinitely soluble in water. In the range n=4-8, the solubility continually decreases with increasing chain length and above n≧9, the corresponding alcohols are virtually completely insoluble in water.

In order to achieve the greatest pronounced hydrophobicity possible of the silicic acid, coating agents which carry organic groups CₙH₂ₙ₊₁ should be particularly suitable, with an increase in the hydrophobicity to be expected with growing chain length.

Surprisingly, however, it has now been found that the hydrophobicity of the silicic acids which are treated with silanes of the general formula (RO)₃SiR′ can be increased up to a chain length of n=14 carbon atoms, whereas the surface modification with alkyltrialkoxysilanes of longer chain length (e.g. n=16 or n=18, as described in EP 0 672 731) does not lead to a further increase, but rather even to a reduction in the value for the hydrophobicity.

As described in EP 1 502 933 A2, the hydrophobic character of a pyrogenic silicic acid can be determined by investigating the wetting behavior of the corresponding samples with a mixture of water and methanol. Herein, a mixture of methanol and water, on which the hydrophobic sample to investigate floats, is continuously admixed with further methanol until the powder is wetted by the liquid phase and sinks into it. The sinking in of the sample becomes evident from increased turbidity of the solution and can be monitored photometrically. Since less light penetrates through the solution to an increasing extent, the transmission decreases rapidly as soon as the sample is wetted. FIG. 1 from EP 1 502 933 A2 shows examples of titration curves of two different samples and proposes the use of the value “methanol wettability”. This value, named hereinbelow “methanol number”, corresponds to the methanol concentration in percent by volume at which the transmission drops to 80% of the original value and is referred to as MeOH₈₀. A higher methanol number therefore reflects a more greatly pronounced hydrophobicity of the investigated sample.

Silicic acids in the context of the invention means oxygen acids of silicon and includes, according to the invention, both precipitated silicic acids which are produced by a wet-chemical method, as well as pyrogenic silicic acids, which are obtained by means of a flame process. These are essentially SiO₂ particles, i.e. oxidic particles of silicon, which carry acidically reacting silanol groups on the surface. Preferably, the silicic acid is silicic acid produced by pyrogenic means.

The silicic acids according to the invention can have specific surface areas of from 1 to 800 m²/g, preferably 40 to 400 m²/g and most preferably 90 to 270 m²/g (determined in accordance with the BET method according to DIN 9277/66131 and DIN 9277/66132).

The tamped densities of the silicic acids according to the invention can be in the range from 10 to 500 g/l, preferably 20 to 200 g/l, and most preferably 30 to 60 g/l (determined in accordance with DIN EN ISO 787-11).

The silicic acids according to the invention are characterized in that they have a residual silanol content of less than 70%, preferably less than 40% and most preferably less than 25%. The residual silanol content after the modification can be determined, for example, by acid-base titration, as described e.g. in G.W. Sears et al. Analytical Chemistry 1956, 28, 1981ff.

The silicic acids according to the invention have a carbon content determined in accordance with DIN ISO 10694 of 0-20%, preferably 5-15%. In a particularly preferred embodiment, the carbon content of the silicic acids according to the invention is 8-12%.

The radical R of the organotrialkoxysilane of the general formula (RO)₃SiR′ is defined as R=C_{q}H_{2q+1} where q=1 to 4.

Preferably, q=1 and the radical R is a methoxy group. Moreover, it is also preferred that q=2 and R is an ethoxy group.

The radical R′ of the organotrialkoxysilane of the general formula (RO)₃SiR′ is defined as R′═CₙH₂₍ₙ₋ₘ₎₊₁, where n=9 to 14, m=0 to n and R=C_{q}H_{2q+1} where q=1 to 4.

n is preferably even-numbered and is preferably 10, 12 or 14, since organotrialkoxysilanes and thus also the correspondingly surface-modified silicic acids, in which n is an uneven-numbered value, are not economical. Most preferably, n is 12 or 14, which means that the chain length of the radical R′ comprises 12 or 14 carbon atoms.

Preferably, the silicic acids according to the invention are characterized in that the groups introduced by the modification are firmly bonded to the surface of the silicic acid. A firm bond means a strong chemical bond and is quantified according to the invention by the fraction of modified silicic acid extractable with solvents, which is preferably at most 15% by weight. More preferably, the extractable fraction is at most 6% by weight, yet more preferably at most 3% by weight, and, in a specific embodiment of the invention, at most 2% by weight. A suitable method for assessing the binding strength of a modification is the quantitative determination of extractable silane, i.e. silane not chemically bonded to the surface of the silicic acid. To ascertain the extractable fraction of the silicic acids according to the invention, the solvent tetrahydrofuran (THF) was used.

A solvent is a substance which can dissolve or dilute gases, liquids or solids without thereby resulting in chemical reactions between the dissolved substance and the substance to be dissolved. The solvent tetrahydrofuran used for investigating the silicic acids according to the invention does not destroy chemical bonds adhering the modification agents to the surface of the silicic acid. The constituents extractable herewith are thus merely joined to the silicic acid by weaker interactions such as, for example, Van-der-Waals forces.

A lower measurement value for the extractable fraction points to better chemical bonding, i.e. firmer bonding of the modification agent to the surface of the silicic acid.

The silicic acids according to the invention have the advantage that they are characterized by a very high hydrophobicity. Preferably, the silicic acids according to the invention have a methanol number (MeOH₈₀) of more than 65% by volume, in particular of more than 70% by volume. In a particularly preferred embodiment, the methanol number of the silicic acids according to the invention is 73% by volume or more.

As described above, methanol number (MeOH₈₀) in the context of the invention is to be understood as meaning the methanol content of an aqueous methanol solution in percent by volume which causes a sinking in of the investigated sample, as a result of which the transmission drops to 80% of its original value. This value, read off from the titration curve, serves for the identification of less well hydrophobicized material which is wetted even at a relatively low methanol content and accordingly sinks in. This less well hydrophobicized material can be excluded as a result.

The silicic acids modified with tetradecyltrimethoxysilane (H₂₉C₁₄Si(OMe)₃) according to the invention of examples 1 to 3 have larger methanol numbers than comparative examples 4 to 6 produced under comparable conditions using the corresponding hexadecyl (H₃₃C₁₆Si (OMe)₃)— and octadecyl (H₃₇C₁₈Si (OMe)₃)— substituted derivatives.

In this connection, it is to be emphasized in particular that the difference in methanol numbers was particularly pronounced if the surface modification of the silicic acids took place by means of a continuous production process particularly preferred for reasons of improved space/time yield (MeOH₈₀ values of examples 2 and 3 according to the invention compared with those of comparative examples 4 and 5), but was established even in the batch process with significantly longer reaction times (MeOH₈₀ values of examples 1 and 7 according to the invention compared to that of comparative example 6). Whereas the silicic acids according to the invention produced in the continuous process in examples 2 and 3 achieve methanol numbers of significantly more than 70, methanol numbers (MeOH₈₀ values) of below 65 are achieved for comparative examples 4 and 5.

The differences in hydrophobicity cannot be explained by fluctuating carbon contents since these were very similar for all of the examples and fluctuate within the scope of measurement accuracy of the corresponding analytical method.

Fluctuating residual silanol contents can also not be used as an explanation since examples 2 and 3 according to the invention have a residual silanol content identical to comparative examples 5 and 4, respectively; however, the methanol numbers are considerably higher according to the invention.

In order to be able to assess the homogeneity of the hydrophobization, the term methanol half-value number (MeOH₅₀) should additionally be introduced here. Analogously to the above definition, this is to be understood as meaning the methanol content in percentage by volume which brings about a reduction in transmission to 50% of the original value. If the two values MeOH₈₀ and MeOH₅₀ are very close together, this is attributed to a rapid decrease in transmission with increasing methanol content and accordingly points to a homogeneous modification of the surface of the corresponding silicic acid since the floating material rapidly sinks at a certain methanol content.

As already explained, a homogeneous modification of the silicic acid is desired in many applications. This is given for the silicic acids according to the invention and has been confirmed in the examples. Thus, the methanol half-value numbers (MeOH₅₀) according to the invention are smaller than the methanol numbers (MeOH₈₀) of the corresponding silicic acids by less than 2% by volume, preferably less than 1% by volume.

By contrast, non-inventive silicic acids, as shown in the comparative examples, often have an inhomogeneous modification of the surface, which manifests itself in a larger difference between the MeOH₅₀ value compared to the MeOH₈₀ value.

Thus, for example, the investigation of the modified silicic acid from Ex. 7 shows that the use of the C18 compound octadecyltrimethoxysilane leads, compared to the homologous C14 compound tetradecyltrimethoxysilane (Ex. 1), to a lower hydrophobicity (methanol number 65.4 compared to 73.3). Moreover, the comparatively large difference between methanol half-value number and methanol number points to a less homogeneous modification of the surface of the corresponding silicic acid.

A further subject matter of the present invention relates to a method for the surface modification of silicic acids, which are treated with a modification agent selected from one or more organotrialkoxysilanes of the general formula (RO)₃SiR′, where R′═CₙH₂₍ₙ₋ₘ₎₊₁ where n=9 to 14 and m=0 to n and R=C_{q}H_{2q+1} where q=1 to 4, in a thermal reaction.

For the radicals R and R′, the definition already given at the start for R and R′ is applicable.

Preferably, the modification agents used (also called coating agents) are monoalkyltrialkoxysilanes such as nonyl-, decyl-, undecyl-, dodecyl-, tridecyl-, tetradecyltrialkoxysilane, most preferably the corresponding methoxy or ethoxy derivaties: nonyl-, decyl-, undecyl-, dodecyl-, tridecyl-, tetradecyltrimethoxysilane or nonyl-, decyl-, undecyl-, dodecyl-, tridecyl-, tetradecyltriethoxysilane. Most preferably, the coating agents are the dodecyl- or tetradecyltrialkoxysilanes dodecyltrimethoxysilane, dodecyltriethoxysilane, tetradecyltrimethoxysilane and/or tetracyltriethoxysilane.

The silicic acids according to the invention can be modified with exclusively one of the aforementioned coating agents, although it is also possible to use a mixture of two or more of the specified coating agents.

Moreover, one or more further coating agents can be used for the surface modification. Preference is given here to using hexamethyldisilazane, linear or cyclic oligo/polydiorganosiloxanes, more preferably oligo/polydimethyldisiloxanes, diorganodichlorosilanes, more preferably also, dimethyldichlorosilane, diorganodialkoxysilanes, also preferably dimethyldimethoxysilane, monoorganotrihalosilanes, also preferably monomethyltrichlorosilane or monoorganotrialkoxysilanes, and most preferably monomethyltrimethoxysilane.

The comparatively higher viscosities of long-chain silane compounds become evident in a negative manner in the production process, as well as in the product quality. For example, the kinematic viscosity (according to DIN 51562-1) of hexadecyltrimethoxysilane (H₃CO)₃SiC₁₆H₃₃ at 25° C. is, as already stated at the beginning, 7.2 mm²/s. By contrast, the kinematic viscosity of tetradecyltrimethoxysilane (H₃CO)₃SiC₁₄H₂₉ at 25° C. is only 5.4 mm²/s. Consequently, the use of the silane compounds according to the invention in the process according to the invention, as well as for the product quality is advantageous. For example, an organotrialkoxysilane where n=16 or 18 is more difficult to handle on account of the higher viscosity than if n is ≦14.

Consequently, the modification method on the basis of using the coating agents according to the invention where n=9 to 14 is advantageous compared to organotrialkoxysilanes where n>14 from economical aspects. For example, an organotrialkoxysilane where n=16 or 18 is more expensive than if n is 14.

The production of the surface-modified silicic acid comprises the reaction of the silicic acid with the coating agent in a thermal treatment. Preferably, the silicic acid is mixed with the coating agent, in which case the mixing takes place most preferably before the reaction. The mixing operation is also referred to as coating. Preferably, the reaction can then be followed by a purification of the modified silicic acid, where most preferably excess modification agent and by-products are removed.

Hereinbelow, the process steps of coating, reaction and purification are referred to by the numbers (1), (2) and (3), even if they are not separate process steps.

Preferably, the preparation process takes place in separate steps which comprise (1) mixing of the silicic acid with the modification agents (coating), (2) reaction of the silicic acid with the coating agent, and (3) purification of the modified silicic acid.

The surface modification (reaction) is preferably carried out in an atmosphere which does not lead to the oxidation of the surface-modified silicic acid, i.e. preferably less than 10% by volume oxygen, and more preferably less than 2.5% by volume. Best results are attained at less than 1% by volume oxygen.

The pressure during the method steps ranges from a slight subatmospheric pressure of 0.2 bar to a superatmospheric pressure of 100 bar, with atmospheric pressure, i.e. pressure-free working compared to external/atmospheric pressure, being preferred for technical reasons.

Optionally, protic solvents can be added. A solvent is described as being protic if a molecule has a functional group from which hydrogen atoms can be cleaved off in the molecule as protons (dissociation). On account of the high polarity of the OH bond, this can be cleaved comparatively easily with the elimination of a positively charged hydrogen atom, the proton.

The most important protic solvent is water, which dissociates (in the simplified explanation) into a proton and a hydroxide ion. Further protic solvents are e.g. alcohols and carboxylic acid. According to the invention, the protic solvents that can be added are preferably vaporizable liquids such as isopropanol, ethanol, methanol, or water. It is also possible to add mixtures of the aforementioned protic solvents. Preference is given to adding 1 to 50% by weight of protic solvents, based on the silicic acid, more preferably 5 to 25%. The addition of water as a protic solvent is particularly preferred.

The modification reaction according to the invention preferably takes place in a gas-phase process, i.e. the coating agent is added to the pure, largely dry (therefore pulverulent) silicic acid. In contrast to this, the silicic acid in a liquid-phase process is introduced into a liquid phase.

The modification agents (coating agent) are preferably added in liquid form to the silicic acid. The modification agents here can be mixed in pure form or as solutions in known industrially used solvents, for example alcohols such as e.g. methanol, ethanol, or isopropanol, ethers such as e.g. diethyl ether, tetrahydrofuran, or dioxane, or hydrocarbons such as e.g. hexanes or toluene. The concentration of the modification agents in the solution here is 5 to 95% by weight, preferably 50 to 95% by weight. The addition in pure form is particularly preferred.

According to the invention, the amounts of the liquid constituents are preferably chosen such that the reaction mixture is always a dry powder bed. A dry powder bed in this connection means that the mixture is present essentially as silicic acid particles dispersed in a gas phase. In contrast to this is the process procedure in liquid phase, i.e. the conversion of a silicic acid dispersed in a liquid phase.

In order to ensure that the reaction mixture is present as a dry powder bed, it is preferred that the amounts by weight of liquid constituents does not exceed the amount by weight of the silicic acid used. Particular preference is given to using 5 to 50, more preferably 20 to 35, parts by weight of liquid constituents, based on 100 parts of the silicic acid.

To produce the silicic acids according to the invention, moreover, substances can be used which make it possible to shorten the reaction times required for the reaction of the silicic acid with the modification agent and/or to reduce the required process temperatures.

The auxiliaries are optionally preferably added in amounts up to 10 μmol per m² surface area of the silicic acid to be modified. Preferably, up to 5 μmol per m² surface area of the silicic acid to be modified, more preferably 0.5 to 2.5 μmol of auxiliary per m² surface area of the silicic acid to be modified are used. The absolute surface area of the unmodified silicic acid can be calculated from its mass and the specific surface area measured in accordance with the BET method (see above).

Preferably, the auxiliaries according to the invention are substances which have functional groups that give an acidic or basic reaction. These include, for example, Brönsted acids, for example organic acids such as formic acid or acetic acid, or inorganic acids such as hydrogen chloride, hydrochloric acid, phosphoric acid, or sulfuric acid. It is also possible to use Lewis acids, such as boron trichloride or aluminum trichloride.

Preferably, the auxiliaries comprise bases such as hydroxides of alkali metals and alkaline earth metals, such as potassium hydroxide and sodium hydroxide, as well as their salts derived from the corresponding alcohols or carboxylic acids, e.g. sodium methylate, sodium ethylate or sodium acetate. Furthermore, the basically reacting compounds can be selected from nitrogen-containing compounds such as ammonia or organically substituted primary, secondary or tertiary amines. The monovalent organic substituents of the specified amines include saturated and unsaturated, branched and unbranched hydrocarbon radicals which, moreover, can also contain further heteroatoms or functional groups. The basic reacting compounds can be added without a diluent or else as solution in inert or reactive solvents. Preference is given to using aqueous sodium or potassium hydroxide solutions, aqueous ammonia solution, isopropylamine, n-butylamine, isobutylamine, t-butylamine, cyclohexylamine, triethylamine, morpholine, piperidine or pyridine.

Preferably, the coating agents are added as very finely distributed aerosol, characterized in that the aerosol has a sink rate of 0.1 to 20 cm/s. An aerosol is a mixture (dispersion) of solid or liquid suspended particles and a gas.

The mixing (coating) of the silicic acid with the specified modification agents preferably takes place by jet techniques or similar techniques. Effective atomization techniques can be, for example, atomization in 1-substance nozzles under pressure (preferably at 5 to 20 bar), spraying in 2-substance nozzles under pressure (preferably with gas and liquid at 2-20 bar), very fine distribution with atomizers or gas/solid exchange units with mobile, rotating or static internals which permit homogeneous distribution of the coating agent with the pulverulent silicic acid. The aerosol can be applied via nozzles from above onto the moving pulverulent solid, in which case the nozzles are located above the liquid level and are surrounded by the homogeneous gas phase, or are introduced into the fluidized solid, in which case the dosing openings are located below the fluid level and are accordingly surrounded by the heterogeneous particle/gas mixture. Preferably, the atomization is from above.

The addition of the silanes, the protic compound and the basic reacting compounds functioning as auxiliaries can take place simultaneously or in succession. Preferably, the coating takes place such that firstly a homogeneous mixture of the silicic acid with the auxiliary and the protic compound is produced, which is then mixed with the silane.

The reaction (step 2) is a thermal treatment and preferably takes place at temperatures of 30° C. to 350° C., more preferably at 40° C. to 250° C., yet more preferably at 50° C. to 150° C. and, in a very preferred embodiment, at 100° C. to 120° C. The temperature course can be kept constant during the reaction or, as described in EP 1 845 136, can have an increasing temperature gradient.

The residence time of the reaction (step 2) is preferably 1 min to 24 h, more preferably 15 min to 300 min and, for reasons of the space/time yield, most preferably 15 min to 240 min.

Coating (1) and reaction (2) preferably take place with mechanical or gas-supported fluidization. Whereas in the case of mechanical fluidization the particulate powder is converted to the fluid state as a result of movement of a body (for example a stirring paddle) in the bed and/or the fluid, in the case of the gas-supported fluidization this is achieved merely by introducing a gas, preferably from below (e.g. in a fluidized bed). A gas-supported fluidization can take place using all inert gases which do not react with the modification agents, the silicic acid and the modified silicic acid, i.e. do not lead to secondary reactions, degradation reactions, oxidation processes and flame and explosion phenomena. Preference is given here to using nitrogen, argon and other noble gases and also carbon dioxide. The introduction of the gases to the fluidization preferably takes place in the range of gas empty pipe flow rates of 0.05 to 5 cm/s, more preferably from 0.5 to 2.5 cm/s. The term gas empty pipe flow rate is to be understood as meaning the quotient of the volume flow rate of the flowing gas which is present in the region in which the steps (1) coating, (2) reaction and (3) purification are carried out, and the free cross sectional area of the area through which gas flows. Particular preference is given to mechanical fluidization which takes place without additional gas introduction beyond inertization, by means of paddle stirrers, anchor stirrers, and other suitable stirring elements.

The purification step (3) is preferably characterized by movement, with slow movement and slight mixing being particularly preferred. The stirring elements here are preferably adjusted and moved such that a mixing and a fluidization, but not complete vortexing, occurs.

During the purification step to separate off unreacted starting materials and any by-products that are formed, the process temperature can optionally be raised. The purification preferably takes place at a temperature of 100° C. to 350° C., more preferably 105° C. to 180° C., and most preferably from 110° C. to 140° C.

In order to avoid oxidation and to make the purification more effective, the purification step can also involve the introduction of larger amounts of a protective gas, preferably nitrogen, argon and other noble gases and also carbon dioxide, corresponding to an empty pipe gas flow rate of preferably 0.001 to 10 cm/s, more preferably 0.01 to 1 cm/s.

Coating, reaction and purification can take place as a discontinuous process (batch process), in which case an amount of material, limited by the capacity of the production vessel, is introduced as a whole to the operating system and is removed from it as a whole after the production process has finished, or may be carried out as a continuous process, i.e. without interruption. For technical reasons, preference is given to a continuous reaction procedure, as described, for example, in EP 1 845 136.

Additionally, during the modification (coating and/or reaction) or after the purification, continuous or discontinuous methods for the mechanical compaction of the silicic acid can be used, such as, for example, compression, press rollers, grinding units such as edge runners or ball mills, compaction by screws or screw mixers, screw compactors, briquettes, or a compaction by aspirating the air or gas content by means of suitable vacuum methods.

Particular preference is given to mechanical compaction by press rollers, grinding units such as ball mills, screws, screw mixers, screw compactors or briquettes during the coating in step (1). Coating and mechanical compaction thus take place in one unit simultaneously, which is positive for reasons of the space/time yield and to eliminate a separate process step.

In a further particularly preferred procedure, methods for mechanical compaction of the silicic acid are used after the purification, such as compaction by aspirating the air or gas content by means of suitable vacuum methods or press rollers or combinations of both methods.

Additionally, the silicic acids can be ground in a particularly preferred procedure after the purification. For this, units such as pinned-disk mills, hammer mills, counterflow mills, impact mills or devices for mill-sifting can be used.

The invention further provides the use of the silicic acids surface-modified according to the invention or of the surface-modified silicic acids produced by the method according to the invention for controlling the flow properties of media such as adhesives, sealants and coating compositions, for improving the mechanical properties of elastomers, as well as for controlling the charge and flow properties of powders such as toners or powder coatings. Preference is given to the use for controlling the rheological properties of liquid media and for use in toners.

The use of the silicic acids modified with the organotrialkoxysilane according to the invention of the general formula (RO)₃SiR′, where R′═CₙH₂₍ₙ₋ₘ₎₊₁ where n=9 to 14 and m=0 to n and R=C_{q}H_{2q+1} where q=1 to 4 is advantageous compared to the prior art since those silicic acids according to the invention, e.g. particularly in polar systems such as aqueous solutions, e.g. in mixtures of water with alcohol, have a high thickening effect.

The silicic acids according to the invention produce dispersions of silicic acids in liquids with strongly basic groups which are characterized by an excellent storage stability relative to viscosity.

Analysis Methods:

1. Determination of the Carbon Content (% C)

The elemental analysis as to carbon was carried out in accordance with DIN ISO 10694 using a CS-530 elemental analyzer from Eltra GmbH (D-41469 Neuss).

2. Determination of the Residual Content of Unmodified Silicic Acid Silanol Groups (% SiOH)

The determination of the residual silanol content was carried out analogously to G.W. Sears et al. Analytical Chemistry 1956, 28, 1981ff by means of acid-base titration of the silicic acid suspended in a 1:1 mixture of water and methanol. The titration was carried out in the range above the isoelectric point and below the pH range of the dissolution of the silicic acid.

The residual silanol content in % (% SiOH) can accordingly be calculated in accordance with the following formula:

% SiOH═SiOH(silyl)/SiOH(phil)*100

where
SiOH(phil): Titration volume from the titration of the untreated silicic acid
SiOH(silyl): Titration volume from the titration of the silylated silicic acid

3. Determination of the Fraction of Extractable Silylating Agent

2.50 g of the silicic acid to be investigated are stirred into 47.50 g of tetrahydrofuran in a screw-top PE vessel using a spatula and the vessel is then closed. After a resting time of 30 min in an ice bath, the mixture is treated for 30 min in an ultrasound bath with ice cooling (Sonorex Digitec DT 156, BANDELIN electronic GmbH & Co. KG, D-12207 Berlin) and then the clear filtrate is obtained by pressure filtration (5 bar nitrogen) over a PTFE membrane filter (pore size: 0.2 μm, diameter: 47 mm, Sartorius AG, Göttingen). Exactly 10.00 ml of this were removed as analyzate to determine the silicon content by means of atomic absorption spectroscopy (Atom Absorption Spectrometer 2100, Perkin Elmer Waltham, Mass., USA) and weighed.

The extractable constituents in % can be calculated as follows:

$$Extractable constituents = {10}^{- 4} \times \frac{m ( THF ) \times V ( Analyzate )}{m ( Silicic acid ) \times M ( Si )} \times \frac{c ( Analyzate ) \times M ( {RSiO}_{3 \text{/} 2} )}{m ( Analyzate )}$$

where
m(THF): Initial weight of tetrahydrofuran (=47.50 g)
V(Analyzate): Volume of the analyzate (=10.00 ml)
m(Silicic acid): Initial weight of the surface-modified silicic acid (=2.50 g)
M(Si): Molar mass of silicon (=28.09 g/mol)
c(Analyzate): Silicon content of the analyzate in mg/1
m(Analyzate): Final weight of the analyzate in g
M(RSiO_{3/2}): Molecular mass of the functional group RSiO_{3/2} in g/mol

4. Determination of Methanol Number (MeOH₈₀) and Methanol Half-Value Number (MeOH₅₀)

The wetting behavior of the samples to be investigated compared to a mixture of methanol and water was carried out in accordance with the analysis method described in detail in EP 1 502 933 paragraphs [0166]ff. This is a titration method in which the turbidity associated with the sinking of the sample to be investigating into a mixture of methanol and water is observed photometrically.

In a beaker (borosilicate, tall shape) of diameter 54 mm, height 95 mm and wall thickness approx. 2 mm, 60 mg of the silicic acid to be investigated are added to 70 ml of a solution of 60% by volume methanol and 40% by volume water. On account of the hydrophobic character of silicic acids with a methanol number of >60, the pulverulent sample firstly floats upwards and the measured transmission remains virtually unchanged. Samples with a less pronounced hydrophobicity or an inhomogeneous surface modification with larger proportions of poorly hydrophobicized material sink as soon as the methanol/water mixture is added partly or in their entirety into the solution and the measured transmission accordingly decreases. The transmission values were therefore measured in all of the examples at the start of the titration and was in all of the investigated cases almost 100%.

With stirring at approx. 800 revolutions per minute (stirrer setting 4.5; 728 magnetic stirrer from Metrohm AG, CH-9100 Herisau) by means of a cylindrical magnetic stirrer bar coated with polytetrafluoroethylene 15 mm in length and 4.5 mm in height, methanol is now added at a rate of 10 ml/min.

The transmission can be observed and recorded using e.g. a powder wetting test instrument WET-100P from Rhesca Company, Ltd. and the methanol number (MeOH₈₀) can be read off from the titration curve. This indicates the methanol content in percent by volume of methanol, at which the transmission has dropped to 80% of the original value (transmission before the addition of the sample to be investigated). Similarly, the methanol half-value number (MeOH₅₀) is read off as methanol content in percent by volume which causes a drop in transmission to 50%.

### EXAMPLES

### Example 1

6.2 g of a 25% strength aqueous ammonia solution were added to 120 g of a hydrophilic silicic acid with a specific surface area of 200 m²/g, determined by the BET method in accordance with DIN 66131 and 66132 (available under the name HDK® N20 from Wacker Chemie AG, Munich, Germany) under a nitrogen atmosphere by atomization via a two-substance nozzle (hollow cone nozzle, model 121, from Düsen-Schlick GmbH, D-96253 Untersiemau/Coburg, 30° spraying angle, 0.1 mm bore, operated at 5 bar nitrogen). Then, 26.3 g of tetradecyltrimethoxysilane were added in an analogous manner (hollow cone nozzle, model 121, from Düsen-Schlick GmbH, D-96253 Untersiemau/Coburg, 30° spraying angle, 0.2 mm bore, operated at 5 bar nitrogen). The reaction mixture was heated at 120° C. for three hours with vigorous stirring.

After cooling the product to room temperature, it is analyzed. The analysis data of the resulting colorless pulverulent reaction product is summarized in table 1.

### Example 2

In a continuous apparatus, in a mixing container under nitrogen atmosphere at a temperature of 41° C. at a mass flow rate of 1000 g/h of a hydrophilic silicic acid with a specific surface area of 200 m²/g, determined by the BET method in accordance with DIN 66131 and 66132 (available under the name HDK® N20 from Wacker Chemie AG, Munich, Germany) by means of atomization via two-substance nozzles, 52 g/h of a 25% strength ammonia solution (hollow cone nozzle, model 121, from Düsen-Schlick GmbH, D-96253 Untersiemau/Coburg, 30° spraying angle, 0.1 mm bore, operated at 5 bar nitrogen), and 220 g/h of tetradecyltrimethoxysilane (hollow cone nozzle, model 121, from Düsen-Schlick GmbH, D-96253 Untersiemau/Coburg, 30° spraying angle, 0.2 mm bore, operated at 5 bar nitrogen) were added. The silicic acid thus charged is reacted in a stirred reaction container by heating to 97° C. for 1.4 h and then purified in a dryer heated to 140° C. for 20 min with mechanical agitation and a nitrogen flow rate of 0.3 Nm³/h.

After cooling the product to room temperature, it is analyzed. The analysis data of the resulting colorless pulverulent reaction product is summarized in table 1.

### Example 3

In a continuous apparatus, in a mixing container under nitrogen atmosphere at a temperature of 41° C. at a mass flow rate of 1200 g/h of a hydrophilic silicic acid with a specific surface area of 200 m²/g, determined by the BET method in accordance with DIN 66131 and 66132 (available under the name HDK® N20 from Wacker Chemie AG, Munich, Germany) by means of atomization via two-substance nozzles, 62 g/h of a 25% strength ammonia solution (hollow cone nozzle, model 121, from Düsen-Schlick GmbH, D-96253 Untersiemau/Coburg, 30° spraying angle, 0.1 mm bore, operated at 5 bar nitrogen), and 264 g/h of tetradecyltrimethoxysilane (hollow cone nozzle, model 121, from Düsen-Schlick GmbH, D-96253 Untersiemau/Coburg, 30° spraying angle, 0.2 mm bore, operated at 5 bar nitrogen) were added. The silicic acid thus charged is reacted in a stirred reaction container by heating to 103° C. for 1.2 h and then purified in a dryer heated to 140° C. for 17 min with mechanical agitation and a nitrogen flow rate of 0.3 Nm³/h.

After cooling the product to room temperature, it is analyzed. The analysis data of the resulting colorless pulverulent reaction product is summarized in table 1.

### Example C4

### Comparative Example

In a continuous apparatus, in a mixing container under nitrogen atmosphere at a temperature of 45° C. at a mass flow rate of 1000 g/h of a hydrophilic silicic acid with a specific surface area of 200 m²/g, determined by the BET method in accordance with DIN 66131 and 66132 (available under the name HDK® N20 from Wacker Chemie AG, Munich, Germany) by means of atomization via two-substance nozzles, 44 g/h of a 25% strength ammonia solution (hollow cone nozzle, model 121, from Düsen-Schlick GmbH, D-96253 Untersiemau/Coburg, 30° spraying angle, 0.1 mm bore, operated at 5 bar nitrogen), and 209 g/h of hexadecyltrimethoxysilane (hollow cone nozzle, model 121, from Düsen-Schlick GmbH, D-96253 Untersiemau/Coburg, 30° spraying angle, 0.2 mm bore, operated at 5 bar nitrogen) were added. The silicic acid thus charged is reacted in a stirred reaction container by heating to 120° C. for 1.4 h and then purified in a dryer heated to 140° C. for 20 min with mechanical agitation and a nitrogen flow rate of 0.2 Nm³/h.

After cooling the product to room temperature, it is analyzed. The analysis data of the resulting colorless pulverulent reaction product is summarized in table 1.

### Example C5

### Comparative Example

In a continuous apparatus, in a mixing container under nitrogen atmosphere at a temperature of 50° C. at a mass flow rate of 600 g/h of a hydrophilic silicic acid with a specific surface area of 200 m²/g, determined by the BET method in accordance with DIN 66131 and 66132 (available under the name HDK® N20 from Wacker Chemie AG, Munich, Germany) by means of atomization via two-substance nozzles, 26 g/h of a 25% strength ammonia solution (hollow cone nozzle, model 121, from Düsen-Schlick GmbH, D-96253 Untersiemau/Coburg, 30° spraying angle, 0.1 mm bore, operated at 5 bar nitrogen), and 125 g/h of hexadecyltrimethoxysilane (hollow cone nozzle, model 121, from Düsen-Schlick GmbH, D-96253 Untersiemau/Coburg, 30° spraying angle, 0.2 mm bore, operated at 5 bar nitrogen) were added. The silicic acid thus charged is reacted in a stirred reaction container by heating to 240° C. for 2.4 h and then purified in a dryer heated to 140° C. for 34 min with mechanical agitation and a nitrogen flow rate of 0.2 Nm³/h.

After cooling the product to room temperature, it is analyzed. The analysis data of the resulting colorless pulverulent reaction product is summarized in table 1.

### Example C6

### Comparative Example

6.1 g of a 25% strength aqueous ammonia solution are added to 120 g of a hydrophilic silicic acid with a specific surface area of 200 m²/g, determined by the BET method in accordance with DIN 66131 and 66132 (available under the name HDK® N20 from Wacker Chemie AG, Munich, Germany) under nitrogen atmosphere by atomization via a two-substance nozzle (hollow cone nozzle, model 121, from Düsen-Schlick GmbH, D-96253 Untersiemau/Coburg, 30° spraying angle, 0.1 mm bore, operated at 5 bar nitrogen). Then, a solution of 22.1 g of octadecyltrimethoxysilane and 14.5 g of toluene is added in an analogous way (hollow cone nozzle, model 121, from Düsen-Schlick GmbH, D-96253 Untersiemau/Coburg, 30° spraying angle, 0.2 mm bore, operated at 5 bar nitrogen). The reaction mixture is heated at 120° C. for three hours with vigorous stirring. After cooling the product to room temperature, it is analyzed. The analysis data of the resulting colorless pulverulent reaction product is summarized in table 1.

### Example 7

6.3 g of a 25% strength aqueous ammonia solution are added to 120 g of a hydrophilic silicic acid with a specific surface area of 200 m²/g, determined by the BET method in accordance with DIN 66131 and 66132 (available under the name HDK® N20 from Wacker Chemie AG, Munich, Germany) under nitrogen atmosphere by atomization via a two-substance nozzle (hollow cone nozzle, model 121, from Düsen-Schlick GmbH, D-96253 Untersiemau/Coburg, 30° spraying angle, 0.1 mm bore, operated at 5 bar nitrogen). Then, 31.8 g of dodecyltriethoxysilane are added in an analogous manner (hollow cone nozzle, model 121, from Düsen-Schlick GmbH, D-96253 Untersiemau/Coburg, 30° spraying angle, 0.2 mm bore, operated at 5 bar nitrogen). The reaction mixture is heated at 120° C. for three hours with vigorous stirring.

After cooling the product to room temperature, it is analyzed. The analysis data of the resulting colorless pulverulent reaction product is summarized in table 1.

TABLE 1
Experimental and analysis data of examples 1-8

| | | | | | Extractable | Transmission | MeOH₈₀ | MeOH₅₀ |
|---|---|---|---|---|---|---|---|---|
| | Coating agent | Process | C | SiOH | constituent | at start of | [% by | [% by |
| Ex. | H₂ₙ₊₂CₙSi(OMe)₃ | procedure | [%] | [%] | [%] | titration | volume] | volume] |
| 1 | n = 14 | Batch | 10.0 | 29 | 1.0 | 97.0 | 73.3 | 74.1 |
| 2 | n = 14 | Continuous | 10.1 | 22 | 1.1 | 98.7 | 73.5 | 74.7 |
| 3 | n = 14 | Continuous | 10.0 | 26 | 1.1 | 99.3 | 71.4 | 72.0 |
| 4 | n = 16 | Continuous | 9.6 | 26 | 1.1 | 94.6 | 64.1 | 65.2 |
| 5 | n = 16 | Continuous | 9.9 | 22 | 0.3 | 97.9 | 64.3 | 65.2 |
| 6 | n = 18 | Batch | 9.7 | 48 | 2.2 | 97.1 | 65.4 | 68.5 |
| 7 | n = 12 | Batch | 10.1 | 21 | 1.3 | 96.8 | 74.1 | 74.9 |

SiOH [%] indicates the content of nonmodified silicic acid silanol groups (residual silanol content).
C [%] indicates the carbon content.
Continuous refers to a continuous preparation process, batch a discontinuous one.

1.-12. (canceled)

13. A surface-modified silicic acid, surface-modified with a composition comprising at least one compound of the formula (RO)₃SiR′, where R′═CₙH₂₍ₙ₋ₘ₎₊₁, n=12 or 14, m=0 to n, and R=C_{q}H_{2q+1} where q=1 to 4,
and the radical R′ is a monovalent, aliphatic or aromatic hydrocarbon radical,
where the methanol number of the modified silicic acids is greater than 65% by volume and
where the silicic acids have a residual silanol content of less than 70% and a carbon content determined in accordance with DIN ISO 10694 of 0-20%.

14. The surface-modified silicic acid of claim 13, wherein the silicic acid to be surface-modified comprises a silicic acid produced by pyrogenic means.

15. The surface-modified silicic acid of claim 13, wherein the radical R is a methoxy group.

16. The surface-modified silicic acid of claim 13, wherein the radical R is an ethoxy group.

17. The surface-modified silicic acid of claim 13, wherein the weight fraction of surface-modified silicic acid extractable with organic solvent is at most 15% by weight.

18. The surface-modified silicic acid of claim 17, wherein the organic solvent is THF.

19. A method of producing a surface-modified silicic acid, comprising treating a silicic acid in a surface-modification reaction with a modification agent comprising one or more organotrialkoxysilanes of the formula (RO)₃SiR′, where R′═CₙH₂₍ₙ₋ₘ₎₊₁ where n=12 or 14, m=0 to n, and R=C_{q}H_{2q+1} where q=1 to 4, in a thermal reaction,
and the radical R′ is a monovalent, aliphatic or aromatic hydrocarbon radical,
where the surface-modification reaction takes place in a gas phase process and a base is used as auxiliary,
the pressure during treating ranges from slight subatmospheric pressure of 0.2 bar to superatmospheric pressure of 100 bar
and where the surface-modified silicic acids have a residual silanol content of less than 70% and a carbon content determined in accordance with DIN ISO 10694 of 0-20%.

20. The method of claim 19, wherein the silicic acids to be surface-modified comprise silicic acids produced by pyrogenic means.

21. The method of claim 19, wherein the radical R is a radical selected from the group consisting of methoxy groups, ethoxy groups, and mixtures thereof.

22. The method of claim 19, wherein the weight fraction of surface-modified silicic acid extractable with organic solvents is at most 15% by weight.

23. The method of claim 22, wherein the organic solvent is THF.

24. The method of claim 19, wherein the methanol number of the surface-modified silicic acid is greater than 65% by volume.

25. The method of claim 19, wherein the modification agent comprises at least one substance selected from the group consisting of dodecyltrialkoxysilane and tetradecyltrialkoxysilane.

26. In a method for controlling the rheological or triboelectric properties of liquid media or for enhancing flow, where a silicic acid is employed, the improvement comprising employing as at least one silicic acid, a surface-modified silicic acid of claim 13.

27. In a method for controlling the rheological or triboelectric properties of liquid media or for enhancing flow, where a silicic acid is employed, the improvement comprising employing as at least one silicic acid, a surface-modified silicic acid produced by the method of claim 19.
